(19) United States
(12) Patent Application Publication
(10) Pub. No.: US 2007/0083881 A1
(43) Pub. Date: Apr. 12, 2007

(54) Clamping structure for optical disc drive

(75) Inventors: Shih Lin Yeh, Hsinchu (TW); Yu Hung Chen, Hsinchu (TW)

Correspondence Address: BIRCH STEWART KOLASCH & BIRCH, PO BOX 747, FALLS CHURCH, VA, 22040-0747, US

(73) Assignee: Lite-On It Corporation

(21) Appl. No.: 11/347,211

(22) Filed: Feb. 6, 2006

(30) Foreign Application Priority Data
Oct. 7, 2005 (TW) 094135110

(51) Int. Cl. G11B 17/028; G11B 19/20; G11B 17/03

(52) U.S. Cl. 720/706

(57) ABSTRACT

A clamping structure for an optical disc drive comprises a top plate and a clamper, in which the top plate is fixedly installed above a turntable and has a damper mounting frame. The damper is supported on the damper mounting frame and has a clamping surface for clamping an optical disc with the turntable. Characteristically, there is an angle between the clamping surface of the damper and a horizontal plane when the damper clamps no optical disc.

This Non-provisional application claims priority under 35 U.S.C. §119(a) on Patent Application No(s). 094135110 filed in Taiwan, Republic of China on Oct. 7, 2005, the entire contents of which are thereby incorporated by reference.

### 1. FIELD OF THE INVENTION

The present invention relates to a clamping structure for an optical disc drive, and more particularly to a clamping structure for an optical disc drive with a function capable of executing an optical disc ejection more effectively.

### 2. DESCRIPTION OF RELATED ART

At present, an optical disc drive can be classified into a slim type optical disc drive, a half height type optical disc drive and a slot-in type optical disc drive according to their disc loading manners. In the slim type optical disc drive, an optical disc is fixed by a hook structure installed on a turntable and then rotated to allow an optical pick-up unit reading data stored on the surface thereof. And, in the half height type optical disc drive or the slot-in optical disc drive, an optical disc is fixed by utilizing a damper to press it on a turntable in which the damper is provided with magnetic elements or made of a magnetic material. The damper is attracted to attach on the turntable through magnetic force so as to clamp the disc between them, and the disc can then be rotated by the turntable to allow an optical pickup unit (OPU) to read data stored thereon.

As to the disc fixing manner of the half height type or the slot-in type optical disc drives, as FIG. 1 shows, it mainly includes a top cover S1 having a hole installed above a spindle motor M of the optical disc drive and a circular magnetic damper C disposed on the hole. A central axis C1 is disposed on the lower surface of the damper C, and a central hole M1 is provided on a turntable M2 corresponding to the central axis C1. Therefore, when the spindle motor M is elevated at a certain height, the central hole M1 is engaged with the central axis C1 of the damper C. At this time, the damper C can be attracted on the turntable M2 due to the magnetic force so as to clamp the disc D and fix it on the turntable M2. Thereafter, the spindle motor M drives the turntable M2 rotating and thus allow the disc D rotating synchronically so as to allow the optical pickup unit (not shown in the figure) to read data on the disc D.

Subsequently, when the spindle motor M is lowered to disengage from the damper C, the damper C is supported on the upper cover S1 and against magnetic force between the damper C and the turntable M2.

However, according to this kind of conventional clamping structure, the contact surfaces between the turntable M2 and damper C are directly separated at the same time so that it needs greater force to separate the turntable M2 and damper C, and the power required to lower the spindle motor M is increased. If the power for lowering the spindle motor is not enough, the failure for de-clamping the damper from the turntable will happen.

For solving the problems mentioned above, the present inventors have conducted an investigation on the clamping structure of an optical disc drive and completed the present invention.

### SUMMARY OF THE INVENTION

The present invention relates to a clamping structure for an optical disc drive, wherein the optical disc drive has a turntable and the clamping structure comprises a top plate and a clamper, in which the top plate is fixedly disposed above the turntable and has a damper mounting frame. The damper is placed on the damper mounting frame and has a clamping surface used for clamping an optical disc with the turntable. Furthermore, there is an angle between the clamping surface of the damper and a horizontal plane when the damper clamps no disc.

According to the clamping structure for an optical disc drive of the present invention, the clamping surface of the damper is faced down and supported on the turntable and attracted by means of magnetic force when the damper clamps an optical disc. At this time, the clamping surface of the damper is in a horizontal state and separated from the damper mounting frame.

By having an angle between the clamping surface of the damper and the horizontal plane, a force needed for separating the damper from the turntable can be reduced so that the separation of the damper from the turntable can be effectively attained.

According to the clamping structure for an optical disc drive of the present invention, the damper mounting frame has an annular supporting plate used for supporting the clamper, and a bump or raised rib is provided on one side of the supporting plate, or the supporting plate has a tilted surface in an angle with the horizontal plane so as to tilt the clamping surface of the damper supported on the damper mounting frame to form an angle with the horizontal plane. Alternatively, a bump or raised rib can also be provided on one side of a rim portion of the clamper, or a rim portion of the damper is designed in a non-horizontal plane.

According to the clamping structure for an optical disc drive of the present invention, the spindle motor is elevated to drive the damper moving upward so as to clamp a disc with the clamping surface of the clamper. When executing the ejection of the optical disc, the spindle motor is lowered, and the damper is first partially separated from the turntable. As the spindle motor is then lowered down continuously, the damper is gradually separated from the turntable completely.

In the present invention, the required force for gradually separating the damper and the turntable from one side is smaller than that for separating the damper directly from the turntable in a perpendicular direction in a conventional design; therefore, the separation of the damper and the turntable can be more effectively attained and the required power is saved.

As to “an angle is formed between the clamping surface of the damper and the horizontal plane” mentioned above in the present invention, it means that a supporting plate of the damper mounting frame for supporting the clamper is a non-horizontal plane. For example, the supporting plate can be set to be two symmetrical planes not disposed at the same horizontal plane, or one or a plurality of bumps, raised ribs or stage differences are provided on one side of the supporting plate so as to incline the clamping surface of the clamper to form an angle with the horizontal plane when the damper is placed in the damper mounting frame without clamping a disc.

Alternatively, the term “an angle is formed between the clamping surface of the damper and a horizontal plane” used herein means that the rim portion of the damper contacting with the damper mounting frame is a non-horizontal plane. For example, the rim portion of the damper can be set to be two symmetrical planes not disposed at the same horizontal plane, or one or a plurality of bumps, raised ribs or stage differences are provided on one side of the rim portion so as to incline the clamping surface of the damper to form an angle with the horizontal plane when the damper is placed in the damper mounting frame without clamping a disc.

### BRIEF DESCRIPTION OF THE DRAWINGS

The present invention can be more fully understood by reference to the following description and accompanying drawings, in which:

FIG. 1 is a cross sectional view showing a clamping structure of a conventional optical disc drive;

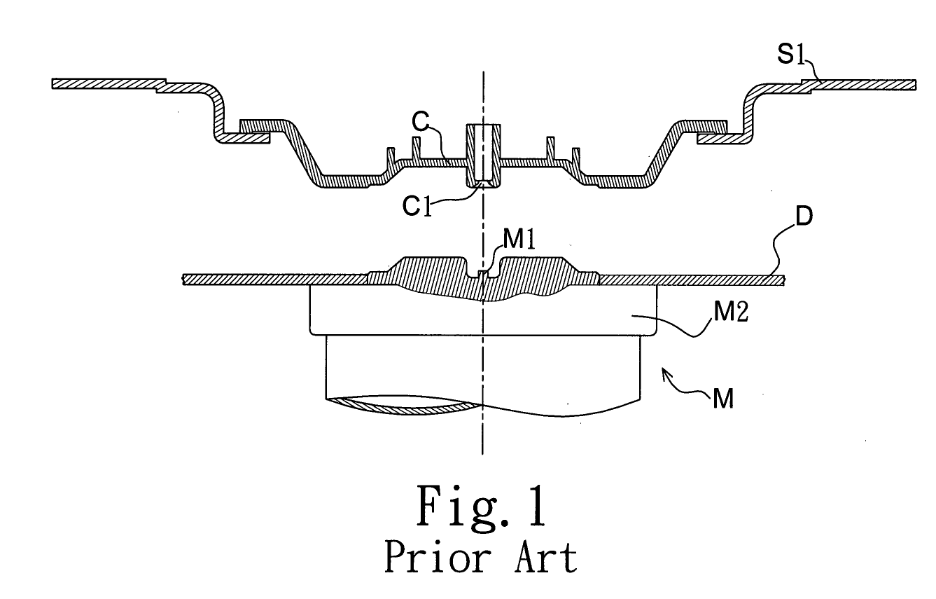

FIG. 2 is a cross sectional view showing a clamping structure of an optical disc drive of a preferred embodiment according to the present invention;

FIG. 3 is a cross sectional view showing the clamping structure in FIG. 2 wherein the clamping structure is in a clamping state with a turntable of a spindle motor; and

FIG. 4 is a cross sectional view showing the clamping structure in FIG. 2 wherein the turntable of the spindle motor is starting to separate from the clamper.

### DETAILED DESCRIPTION OF THE PREFERRED EMBODIMENTS

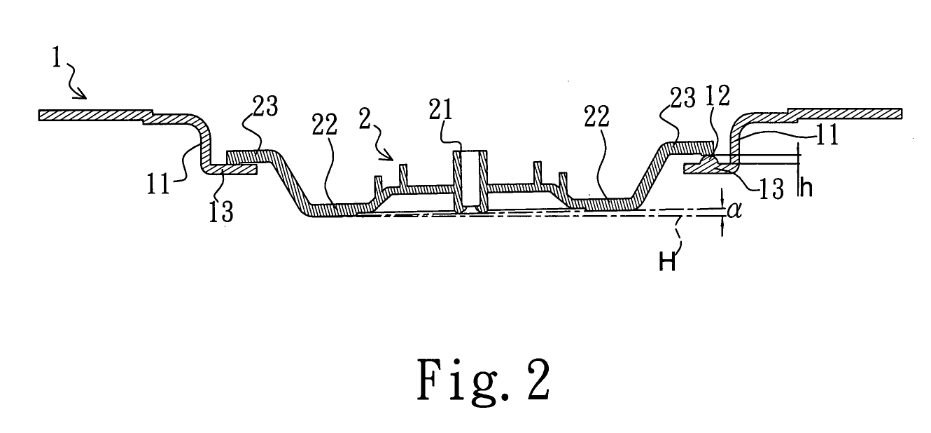

Please refer to FIG. 2. FIG. 2 is a cross sectional view showing a clamping structure for an optical disc drive of a preferred embodiment of the present invention. As the figure shows, a clamping structure comprises a top plate 1 and a damper 2, in which the top plate 1 is disposed fixedly above a turntable of an optical disc drive and is provided with a damper mounting frame 11. The damper 2 is movably mounted on the damper mounting frame 11 and has a clamping surface 22 used for clamping an optical disc with the turntable of the disc drive by means of magnetic force. The clamping surface 22 of the damper 2 forms an angle α with a horizontal plane H when the damper 2 clamps no disc.

According to the preferred embodiment of the present invention, the damper mounting frame 11 has an annular supporting plate 13. The annular supporting plate 13 is horizontally disposed and used for mounting the damper 2, and a bump 12 is disposed on one side of the supporting plate 13 so as to provide a stage difference h relative to another side of the supporting plate 13. When the damper 2 is mounted on the supporting plate 13 of the damper mounting frame 11, the clamping surface 22 of the damper 2 forms the angle α with the horizontal plane H. The damper 2 has a central protruding axis 21 and a rim portion 23 supported on the annular supporting plate 13 of the damper mounting frame 11. Accordingly, one side of the rim portion 23 of the damper 2 is directly mounted on the supporting plate 13, and another side thereof is placed on the bump 12 so as to slightly tilt the clamping surface 22 of the damper 2 and form an angle between the clamping surface 22 and the horizontal plane H when the damper 2 clamps no disc. This central protruding axis 21 is utilized to match with a spindle motor (not shown in the figure). Furthermore, the clamping surface 22 is made of magnetic material or disposed with a magnet so as to be attracted to the turntable of the spindle motor of the disc drive to clamp and fix the optical disc.

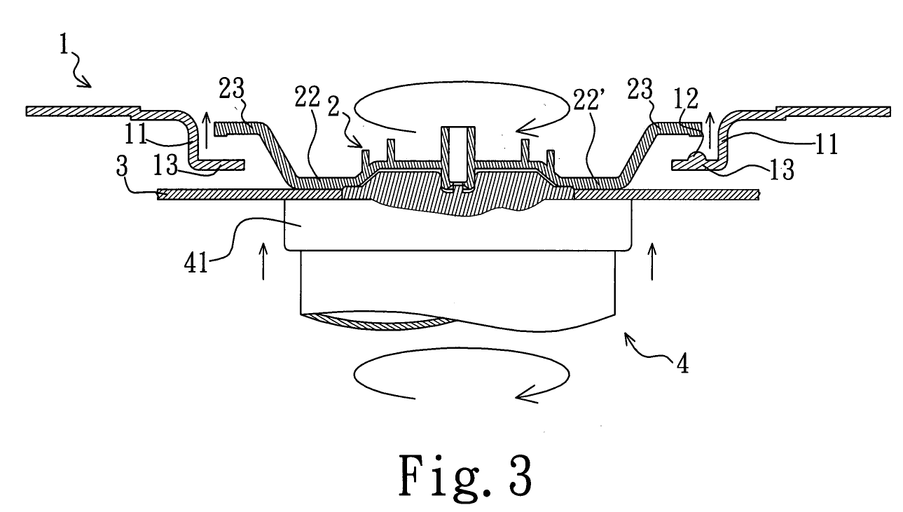

Please refer to FIG. 3. FIG. 3 is a cross sectional view showing the clamping structure in FIG. 2 in which the clamping structure is in a clamping state with the turntable of a spindle motor. When an optical disc 3 is loaded in, the spindle motor 4 is elevated a certain height to support the optical disc 3 and the damper 2. In the meantime, the rim portion 23 is separated from the supporting plate 13 of the damper mounting frame 11 and the clamping surface 22 is attracted to the turntable 41 by means of the magnetic force so as to fix the optical disc 3 between the damper 2 and the turntable 41 to execute the rotation of the optical disc 3 and allow an optical pickup unit to read data stored on the disc 3.

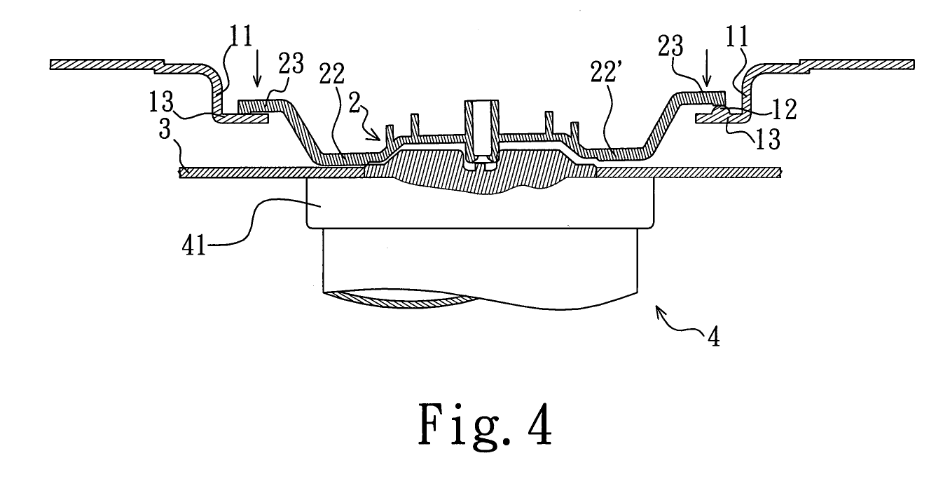

Furthermore, please refer to FIG. 4. FIG. 4 is a cross sectional view showing the clamping structure in FIG. 3 in which the clamping structure is starting to separate from the turntable of a spindle motor. As FIG. 4 shows, the optical disc 3 is placed on the turntable 41 installed on the spindle motor 4. When the disc 3 is to be ejected out of the disc drive, the spindle motor 4 is lowered and the damper 2 is also lowered accordingly. Thereafter, as FIG. 4 shows, one side of the rim portion 23 of the damper 2 first contacts the bump 12 disposed on one side of the supporting plate 13 of the damper mounting frame 11. The corresponding portion of the clamping surface 22′ of the damper 2, therefore, is first separated from the turntable 41 owing to the supporting of the bump 12. As the spindle motor 4 is kept on descending, the another side of the rim portion 23 of the clamper 2 contacts the another side of the supporting plate 13 of the damper mounting frame 11 continuously so as to separate the damper 2 from the turntable 41 completely.

In the clamping structure of the optical disc drive of the present invention, it is most primarily characterized in that a stage difference is provided on the supporting plate 13 of the damper mounting frame 11 used for supporting the damper 2 to cause the clamping surface 22 of the damper 2 to be non-horizontal and forms an angle α with a horizontal plane H when the damper 2 clamps no disc. However, the manner to provide a stage difference causing the clamping surface 22 of the damper 2 to be non-horizontal when the damper 2 clamps no disc is not limited, it can be attained not only by disposing a bump on the damper mounting frame described in the embodiment of the present invention, but also by replacing, the bump with a rib. Besides, it also can form the supporting plate 13 of the damper mounting frame 11 directly into one or multiple steps to form a stepped supporting plate or allow the supporting plate 13 to directly form an angel with the horizontal plane, as long as the clamping surface 22 of the damper 2 mounted on the damper mounting frame 11 is non-horizontal and forms an angle with the horizontal plane when the damper 2 clamps no disc.

Otherwise, the rim portion 23 of the clamper 2 supported on the supporting plate 13 of the damper mounting frame 11 can set to be non-horizontal, for example, the rim portion 23 of the clamper 2 can be composed of two symmetric planes at different horizontal plane. Alternatively, one or multiple bumps or ribs are disposed on one side of the rim portion 23, or a stage difference is formed on the rim portion 23, as long as the clamping face 22 is non-horizontal and forms an angle with the horizontal plane when the damper 2 clamps no disc. For example, the bump 12 can be disposed on a one side surface of the rim portion 23 of the damper 2 contacting with the supporting plate 13 of the damper mounting frame 11.

Furthermore, the top plate in the present invention can also be an upper cover of an optical disc drive. Namely, the clamper can be installed directly on the upper cover without needing to install an additional top plate in the disc drive to accept the clamper.

According to the present invention, the clamping surface of the damper is allowed to form an angle with the horizontal plane when the damper clamps no disc by forming a stage difference on the supporting plate of the damper mounting frame or on the rim portion of the damper to separate the damper from the turntable starting from the side where the stage difference disposed. Therefore, the force required to separate the damper from the turntable is reduced so as to de-clamp the damper from the turntable more effectively, and save the output power of the motor.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A clamping structure for an optical disc drive, said optical disc drive has a turntable, said clamping structure comprising:
a top plate, fixedly disposed above said turntable and having a clamper mounting frame thereon; and
a clamper, supported on said clamper mounting frame and having a clamping surface for clamping an optical disc with said turntable;
wherein said clamping surface of said clamper forms an angle with a horizontal plane when said clamper clamps no optical disc.

2. The clamping structure according to claim 1, wherein said clamper mounting frame has a supporting plate for supporting said clamper, and a bump is disposed on one side of said supporting plate.

3. The clamping structure according to claim 1, wherein said clamper mounting frame has a supporting plate for supporting said clamper, and a rib is disposed on one side of said supporting plate.

4. The clamping structure according to claim 1, wherein said clamper mounting frame has a supporting plate for supporting said clamper, said supporting plate has a stage difference.

5. The clamping structure according to claim 1, wherein said clamper has a rim portion for being mounted on said clamper mounting frame, and a bump is disposed on one side of said rim portion.

6. The clamping structure according to claim 1, wherein said clamper has a rim portion for being mounted on said clamper mounting frame, and a rib is disposed on one side of said rim portion.

7. The clamping structure according to claim 1, wherein said clamper mounting frame has a supporting plate used for supporting said clamper, said supporting plate forms said angle with the horizontal plane.

8. The clamping structure according to claim 1, wherein said clamper is separated from said clamper mounting frame when said clamper and said turntable are clamped together.
